(19) United States
(12) Patent Application Publication
(10) Pub. No.: US 2002/0032768 A1
(43) Pub. Date: Mar. 14, 2002

(54) Method and system for configuring remotely located applications

(76) Inventor: Erik K. Voskuil, Somersworth, NH (US)

Correspondence Address: MINTZ, LEVIN, COHN, FERRIS,, GLOVSKY and POPEO, P.C., One Financial Center, Boston, MA, 02111, US

(21) Appl. No.: 09/829,423

(22) Filed: Apr. 9, 2001

Related U.S. Application Data
(60) Provisional application No. 60/196,075, filed on Apr. 10, 2000.

(51) Int. Cl. G06F 15/16; G06F 15/173

(52) U.S. Cl. 709/224; 709/203

(57) ABSTRACT

A system for automatically configuring applications installed on an end user computer system includes an autoprofile server connected to a network such as the Internet. The end user computer includes a third party client application that communicates with the autoprofile server to send information to and receive information from the end user computer. The client application can include extensions that provide extended functionality for the client application. The extensions can be transferred to and installed in the end user computer system. The extension also receive instructions or programs that instruct the extensions to detect whether a particular application is installed on an end user computer and configure or reconfigure the application according to the end user's or a third party's requirements.

### COPYRIGHT NOTICE

Copyright, 1999, 2000 Autoprof.com, Inc. A portion of the disclosure of this patent document contains material which is subject to copyright protection. The copyright owner has no objection to reproduction by anyone of the patent document or the patent disclosure, as it appears in the U.S. Patent and Trademark Office patent file or records, but otherwise reserves all copyright rights whatsoever.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### BACKGROUND OF THE INVENTION

This invention relates to methods and systems for configuring remotely located software applications and/or application components and, more particularly, to a method and system for discovering the presence and configuration of one or more remotely located software applications and/or components and for determining and making changes to the configuration.

Personal computers (“PCs”) are essentially becoming appliances, which can perform specified functions and allow individuals to connect to remote access services via a global network such as the Internet. In some instances, it is necessary to configure the PC and/or its software in order to enable it to perform a desired function. While many applications are configured during installation, this default configuration may not always be suitable for all users or situations. In addition, it may be necessary from time to time to change an application's configuration. For most users, changing all but the most fundamental configuration parameters can be daunting task. The result is a high level of user frustration and a less than satisfactory user experience. In the end, the user is forced to call technical support, driving up technical support costs.

Service Providers (“SPs”) such as Internet Service Providers (“ISPs”) commonly offer multiple services to their subscribers including Internet connectivity, E-mail Services (POP3/IMAP4/SNTP), newsgroups (NNTP), file transfer (FTP), web services (HTTP/S) and as well as other services. Other SPs such as Application Service Providers (“ASPs”) and providers of corporate internetworking services can offer a much broader range of services including (software) application services. The primary cost factor associated with providing these services is often the cost of supporting the end user configuration on both desktop and portable systems. In many instances, each of the various applications must be properly configured before the end user can take advantage of all the features of an application and/or communicate with the services provided by the SP.

Currently, the task of configuring the PC is primarily the responsibility of the end user. This is accomplished by providing the end user with printed documentation, an online tutorial, or various types of customer support (e.g. telephone support or email support). In other situations, the end users are provided with an installation disk (or disks) and/or must download a large software package which couples the installation of the new software with configuration. There are several drawbacks to this method. Because customized installation distributions impose significant costs and complexity factors and complicate the end user experience, typical installation distributions are not provided with more than a basic “default” configuration. Often the package reinstalls an application that is already present and/or installs software other than that which is desired or with which the end user is familiar. This may require the end user to learn a new application for no reason other than to implement a reliable configuration. In many cases the end user may still be using a different application for a similar purpose at the same time. The installation process may make many changes to the end user's system and as a result, may actually increase the likelihood of failure of installed applications and thus require additional technical support calls. Currently, technical support personal have few services or systems that allow them to automatically and remotely configure software on their end user systems. Accordingly, it is an object of this invention to provide an improved system for configuring software applications and/or application components installed on a remotely located computer system.

It is another object of this invention to provide an improved method for configuring software applications and/or application components installed on a remotely located computer system.

### SUMMARY OF THE INVENTION

The present invention is directed to a method and system which can automatically determine the identity of installed applications and/or application components on a remote computer system and configure one or more of the identified applications and/or application components installed on the same remote computer.

The system can automatically determine which applications and/or application components are installed on the remote computer, allow the end user to select the applications they desire to be configured, automatically configure the selected applications and/or application components specified by the end user and record the success, failure or any errors resulting from the configuration of each application and/or application component.

The system includes an end user computer connected to an autoprofile server that can send information to and receive information from the end user computer. An application on the end user computer communicates with the autoprofile server and can receive and execute extension modules that expand the functionality of the application. The autoprofile server can include a repository of extension modules that are adapted for detecting the installation of one or more applications on the end user computer and reporting the identity of the detected applications and their configuration information to the autoprofile server. The autoprofile server can use this information to prompt the end user to select the application or applications that are to be automatically configured. The autoprofile server can then use the information concerning the detected applications and their existing configuration to select the configuration instructions to be sent to the end user computer to automatically configure each installed application according to the end user and/or third party requirements.

The method includes the steps of a remotely located end user computer establishing a communication session with a service provider server, optionally, the service provider server transparently transferring or redirecting the session to an autoprofile server, the autoprofile server transferring a discovery module and/or discovery information to the end user computer, executing the discovery module on the end user computer to generate data representative of the installed applications, application components, and/or application configurations on the end user computer, transferring the data representative of the installed applications, application components, and/or application configurations to the autoprofile server, querying the end user to indicate which installed applications and/or application components the user desires configured, for each installed application and/or application component, analyzing the data representative of the installed application and/or application component to determine the proper configuration for each, optionally integrating the configuration data with the service provider's user directory, transferring a configuration module and/or configuration information to the end user computer, executing the configuration module to configure each installed application and/or application component selected by the end user, generating and transferring data representative of the results of configuration of each application and/or application component, reporting the results of the configuration to the end user, and logging the results on the autoprofile server for access by the service provider.

The end user computer can include a client application that is used to communicate with the autoprofile server. The client application can have the ability to be extended by external or third party software components or modules. The autoprofile server can include an autoprofile extension, a client application extension that can be transmitted to and installed on the end user computer. Once the autoprofile extension is installed on the end user computer, the autoprofile extension can send information to and receive autoprofile information from the autoprofile server.

The autoprofile extension can include one or more autoprofile modules. Each module can include one or more functions that can be used to access files on the end user computer, search for information in a file, modify an existing file, or create a new file as necessary to configure a given application. The autoprofile modules can be instructed or programmed to execute one or more of the library of functions by a list of instructions received from the autoprofile server. The autoprofile discovery information can be used to program the autoprofile discovery module to search for one or more installed applications, application components, or application configurations. The autoprofile server can use the results of the autoprofile discovery process, as well as end user and SP preferences, to create configuration instructions. The autoprofile configuration module performs the configuration of applications or application components in accordance with the configuration instructions and reports the results back to the autoprofile server.

Alternatively, the invention can utilize a plurality of autoprofile extensions, each preprogrammed to perform a predetermined function and sent to the remote computer. A discovery autoprofile extension can include a plurality of related functions that can be used to access files on the end user computer, search for information in a file to search for one or more installed applications, application components, or application configurations. The discovery autoprofile extension can report the results of its search in the form of an output message or report identifying the installed applications, application components, or application configurations that were found. The output message or report can be communicated to the autoprofile server. The autoprofile server can use the information contained in the output message or report, as well as end user and SP preferences, to select or create a configuration autoprofile extension adapted to configure one or more applications or application components in accordance with a predefined configuration. The autoprofile extension can be sent to the remote computer whereby upon execution, the configuration autoprofile extension configures one or more applications or application components according to a predefined configuration and reports the results back to the autoprofile server.

### BRIEF DESCRIPTION OF THE DRAWINGS

The foregoing and other objects of this invention, the various features thereof, as well as the invention itself, may be more fully understood from the following description, when read together with the accompanying drawings in which:

FIG. 1 shows a diagrammatic view of a system according to the present invention;

FIG. 2 shows a diagrammatic view of a system according to the present invention;

FIG. 3 shows a flow diagram of a method in accordance with the present invention.

### DETAILED DESCRIPTION OF THE PREFERRED EMBODIMENTS

The present invention is directed to a method and system for automatically determining the applications and/or application components stored or installed on a remotely located computer system and for automatically configuring one or more applications and/or application components installed on the remote computer. By way of example and in order to facilitate a further understanding of the invention, the invention is described below as embodied in a method and system for automatically determining the applications and/or application components installed on a remotely located computing device such as an IBM compatible personal computer system connected to a service provider server via a network such as the Internet and for automatically configuring one or more applications and/or application components installed on the remotely located IBM compatible person computer.

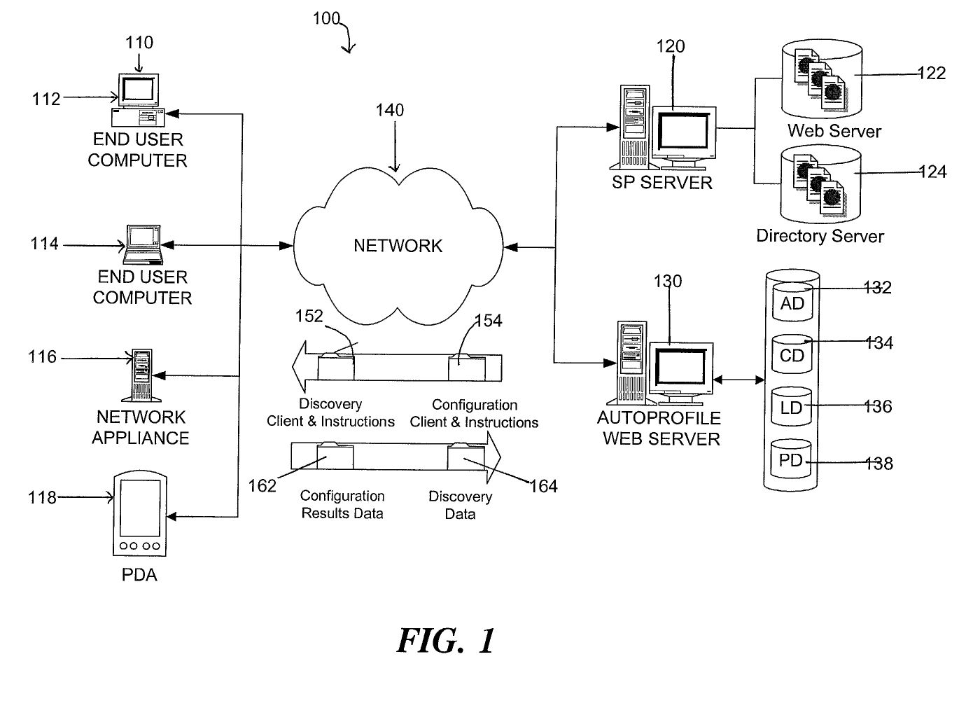

FIG. 1 shows a system 100 in accordance with the present invention. The system 100 includes one or more end user or remote devices 110 connected to a service provider (“SP”) server 120 and an autoprofile server 130 via a network 140 such as the Internet. The SP server 120 can include a web server that allows the service provider to transfer web pages 122 to one or more remote devices 110, and a directory server 124 that can store and provide end user account information to the autoprofile server 130. The autoprofile server 130 can include a web server and one or more databases 132, 134, 136, 138 that enable the autoprofile server 130 to transfer program code and data 152, 154 to a remote device 112, 114, 116, 118 and receive results data 162, 164. The autoprofile server 130 can obtain information about the end user from the SP directory server 124 either directly or as provided by the ISP's web server.

As a person having ordinary skill in the art will appreciate, the SP server 120 and the autoprofile server 130 can be located in the same physical computer and can be accessed through the same URL (Universal Resource Locator). Alternatively, the SP server 120 and the autoprofile server 130, as well as each of the autoprofile databases 132, 134, 136 and 138 can be located on different computers and each accessed by its own (possibly different) URL. The SP server 120 and the autoprofile server 130 can be run on one or more Microsoft Windows compatible servers under the Microsoft Windows NT Server Operating Systems and Microsoft Internet Information Server (both available from Microsoft, Corp., Redmond, Wash.) or one or more LINUX based servers such as those available from IBM Corp, Armonk, N.Y., and Redhat, Inc., Durham, N.C. Alternatively, the SP server 130 and the autoprofile server 130 can be run on one or more UNIX based servers such as those available from Sun Microsystems of Palo Alto, Calif. or Hewlett Packard of Palo Alto, Calif.

In accordance with the invention, the remote device 110 can be desktop or portable IBM compatible personal computers (“end user PCs”) 112, 114 running the Microsoft Windows operating system and utilize a client application, such as a web browser, for example Netscape Navigator or Microsoft Internet Explorer, to communicate over the Internet with the service provider server 120 and the autoprofile server 130 using a communication protocol such as hypertext transfer protocol (HTTP). The end user PC 112, 114 sends HTTP requests for web pages to the service provider server 120 and the autoprofile server 130. In response to the requests, the service provider server 130 and/or the autoprofile server 130 send web pages over the Internet to the end user PC 112, 114 that requested the web pages.

In accordance with the invention, the remote device 110 can be a network appliance 116, such as file server or print server, which is connected to the network 140. In this embodiment, the network appliance 116 can utilize conventional client software such as a Microsoft Windows operating system or the network appliance 116 can utilize server software such as Microsoft Windows NT or Redhat LINUX and a compatible application (such as Netscape Navigator or Microsoft Internet Explorer) capable to communicating over the network 140 with the SP server 120 and autoprofile server 130.

In accordance with the invention, the remote device 110 can be device more commonly known as a personal digital assistant (“PDA”) 118, such a Palm VII (Palm Computing, Santa Clara, Calif.) or a Blackberry (Research In Motion, Limited, Waterloo, Ontario). These devices 118 are capable of sending and receiving data over the network 140 using well known wireless communication technology and their operating systems can support autoprofile extensions either by downloading additional applications or upgrading the operating system. In this embodiment, the autoprofile extension can be an application directly supported by the operating system or an extension to an existing application already supported by the operating system.

As one of ordinary skill will appreciate, the remote devices 110 can utilize any application that can communicate with the autoprofile server 130 over the network 140. In addition to enabling the remote devices 110 to communicate with remote servers, the client application should include the ability to execute plug-ins or extensions to the client application, such as for example, Microsoft Active-X controls and/or Netscape plug-ins, that are capable of creating, and reading from and writing to files on the remote device 110 or the ability to spawn processes that are capable of creating, and reading from and writing to files on the remote device 110. In one embodiment, the plug-ins or extensions can be transferred from the autoprofile server 130 to the remote device 110 prior to execution. Alternatively, the plug-ins or extensions can be included with the client application or may be implemented as standalone applications having the ability to read from and write to files with their own communications capability.

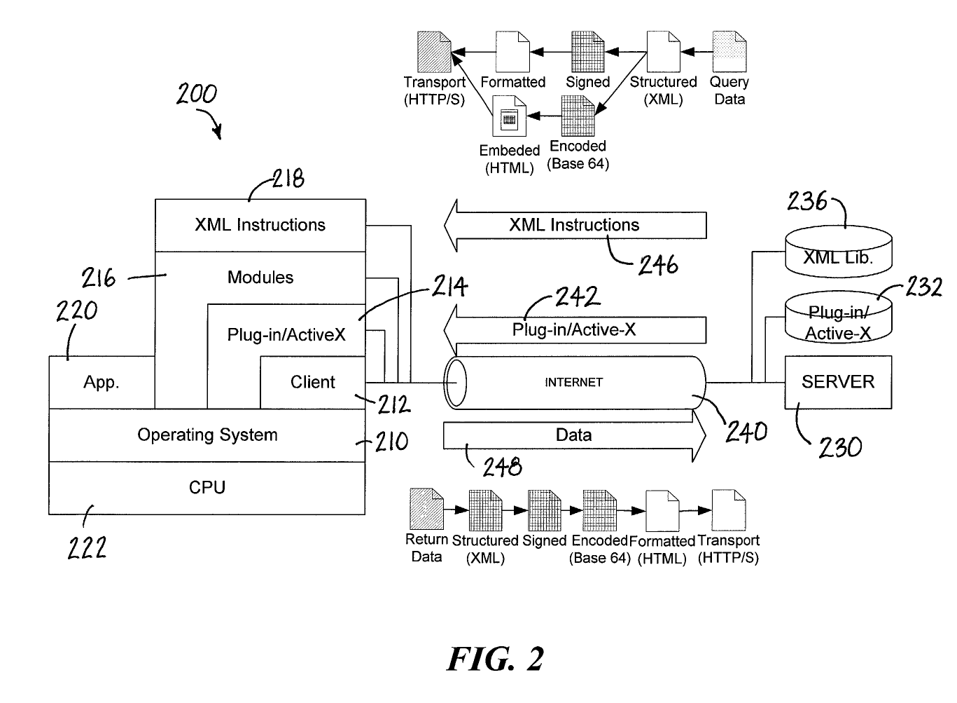

FIG. 2 shows a diagrammatic view of a system 200 for determining which applications and/or application components are installed on a remote PC and for configuring one or more of the applications and/or application components in accordance with the present invention. In one embodiment, the system 200 includes a client operating system 210 installed on one end user PC connected to a remotely located server 230 via a network 240 such as a TCP/IP network or the Internet. A client application 212, such as Netscape Navigator or Microsoft Internet Explorer, is used to communicate with a remotely located profile server 230 over the network 240 via HTTP.

The client application 212 supports an extension interface such as Netscape Navigator's plug-in interface 214, Microsoft Internet Explorer's Active-X controls 214 or Sun Microsystems Java 214 that allow the client application 212 to be extended to permit additional functionality. The extension interface 214 permits extension modules 216 (e.g. plug-ins or Active-X controls) to access the file system to create, read and write to files on the remote PC. Alternatively, the extension interface 214 can permit the spawning of a process that can access the file system to create, read and write to files on the end user PC. In the illustrative embodiment, this can be accomplished via either a Netscape plug-in or a Microsoft Active-X control that includes one or more modules 216 common functionality that permit the extension module to access the file system as necessary to detect create and modify files in order to automatically configure the remote PC. The extension modules 216 can be adapted to receive instructions from the profile server 230 regarding the files to be examined or modified and specific modifications to be made. In one embodiment, the instructions can be incorporated in an XML data structure 246 that is transmitted from the server 230. The XML instructions dictate which modules and functions are executed, the parameters for each, and how the results are processed. Alternatively, the extension modules 216 can be preprogrammed to perform some or all of the necessary tasks to discover and/or configure applications on the remote PC, without receiving instructions from the server 230.

In accordance with the invention, the profile server 230 can transfer the XML instructions to the remote PC using the same data channel with which the autoprofile server 230 communicates with the client application guaranteeing that the communications channel is valid. Secure communications channels can be provided using well know protocols such as Secure Sockets and HTTPS.

In the illustrative embodiment, and in accordance with the invention, the client extension modules 216 (i.e. the Netscape plug-in or a Microsoft Active-X control) can be transferred 242 from the profile server 230 to the remote PC as necessary. Alternatively, extension modules 216 can be incorporated in the client 212 (e.g. included with the client distribution or installation). The extension modules 216 may be packaged in self-installing and digitally signed containers to facilitate their installation. The extension modules 216 can be controlled and executed by instructions, such as XML instructions, transferred from the profile server 230.

In accordance with the invention, the extension modules 216 can be controlled and executed by instructions, such as XML instructions, transferred from the profile server 230. This embodiment may be suitable for supporting many different CPU architectures, operating system configurations, and new functionalities. The server 230 can include a library 232 of extension modules 216 that are compatible with a wide range of client applications 212, operating systems 210, and CPU architectures 222, and a library 236 of XML instructions 218 that are compatible with a wide range of desktop applications 220, systems, and architectures. The server 230 can dynamically generate the XML instructions 218 from a data repository as a function of the operating system, CPU architecture, client application and/or extension module. Thus, server 230 can be easily adapted to automatically configure virtually any type of end user system capable of running a supported client application 212 and communicating with the profile server 230.

The modules 216 can include a plurality of functions that can be performed as a function of a set of commands received from the profile server 230. In one embodiment, these commands can be executed in a batch mode in which a predetermined set of functions is executed in sequence. Additionally, a sequence of functions can be executed in response to a sequence of individual instructions received from the profile server 230. In either event, the data to be transferred to the end user PC is processed according to a communications process. The communications process includes rendering the instructions as an XML data structure 246. This can be accomplished by assembling a plurality of data reformulated as XML or components from the customization database CD 134, the application database AD 132 and the service provider database PD 138. The XML data can be digitally signed to identify the source of the data. Similarly, XML data 248 passed back to the profile server 230 can be digitally signed.

The syntax of each XML document is in accordance with software industry XML standards. The organization of data within the document is unique and dependent upon the situation. There is a unique XML schema designed for use with each module's input and output. The schema governs which document arrangements are valid and guarantees that the module will properly interpret the XML. The XML, in accordance with the schema, governs the entire operation of a module, and which modules are executed.

In accordance with the invention, the configuration process can be divided into two steps, the first or discovery step including identifying which applications or application components are stored or installed on the end user computer 110 and the second or configuration step including configuring one or more of applications that are identified. The step of identifying which applications or application components are installed on the end user computer 110 can be accomplished by any known method for detecting the installation of an application. In accordance with the invention, the discovery step can include searching one or more directories or file structures for a specific file and/or searching a particular file, registry or other index of installed applications as the operating system may provide. The extension modules 216 can search for specific files by name and/or version identifier or search within one or more files for specific data or information indicative of the applications installed on the end user computer 200. In accordance with the invention, the configuration step can include creating and/or modifying one or more configuration files, registries or other index according the configuration requirements of a particular application and operating system. The autoprofile extension modules 216 can search for and modify specific files according to predefined configuration information or search for and modify, within one or more files, specific data or information that is associated with the configuration of one or more applications installed on the end user computer 200 or create one or more files associated with a predefined configuration of one or more applications installed on the end user computer 200.

In accordance with the invention, the illustrative embodiment describes a system in which the target application (the application to be configured) is installed on the remote computing device. As a person having ordinary skill will appreciate and in accordance with the present invention, the target application can be stored on the remote computing device or a storage device accessible by the remote computing device, in a distribution format that permits the target application to be first installed by the extension module 216. In this situation, in accordance with the present invention, the extension module 216 could detect the target application (in distribution format), install the target application and then configure the target application in accordance with the invention. In addition, the target application can be installed using the predefined default installation configuration parameters, installation parameters provided by the user or installation parameters provided by the profile server 230 (possibly making some or all subsequent configuration steps unnecessary).

In accordance with the invention, the method for automatically configuring an end user PC in accordance with the present invention includes the steps of A) establishing a connection between a service provider server and a remotely located end user computer; B) transferring control from the service provider server to a profile server; C) transferring an extension to the end user computer; D) executing the extension's discovery module on the end user computer to generate data representative of the installed applications and/or application components on the end user computer; E) transferring the data representative of the installed applications, application components, and/or configurations to the profile server; F) querying the user to indicate which installed applications and/or application components the user desires configured; G) for each installed application and/or application component, analyzing the data representative of the installed application and/or application component to determine the proper configuration for each; H) integrating data from the service provider's user directory into configuration data; I) transferring configuration data to the end user computer; J) executing the extension's configuration module to configure each installed application and/or application component selected by the end user; K) generating and transferring data representative of the results of configuration of each application and/or application component; L) reporting the results of the configuration to the end user; and M) storing the results of the process.

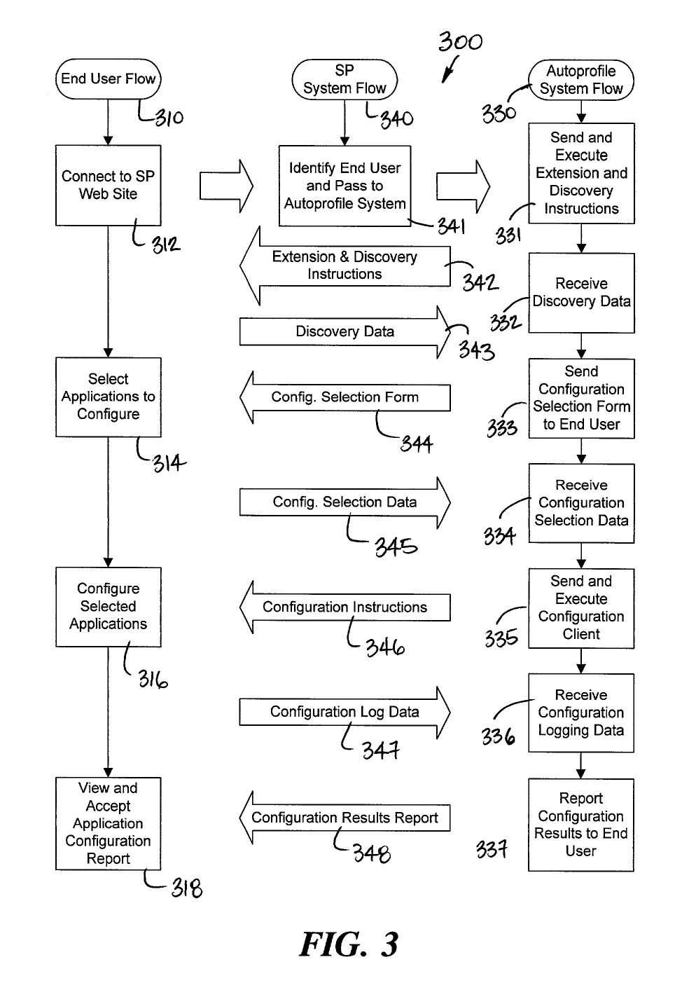

FIG. 3 is a flow chart that shows a method 300 for automatically configuring an end user PC in accordance with the present invention. In this embodiment, the end user is directed to a web site or a web page as part of the configuration process after initial service sign-up or as the result of requesting support from the service provider's technical support site. From the end user perspective, the end user process 310 is intended to be simple and easy for the end user to follow. The SP process 340 and the autoprofile System process 330 work together to configure the end user system according to the SP's requirements. The end user is directed to a SP web site 312, where the SP web site is able to identify the end user 341. This can be accomplished by requiring the end user to login or the client application may able to report the identity to the server or the server may be able to obtain this information such as through a previously stored “cookie” or a similar ID token. The SP system passes the end user identity information to autoprofile system at step 341. The autoprofile system receives the end user identity information and establishes a session identifier and log file to record the activity associated with the end user configuration process. The autoprofile system sends a discovery client module 342 to be executed on the end user system at step 331. The discovery client module 342, as described above can be included in a client application extension (e.g. a Netscape plug-in or Microsoft Active-X control). The discovery XML instructions can be specifically configured or programmed to cause the discovery module to search for the installed programs and their components that are to be configured according to the SP's requirements. The discovery XML instructions instruct the client application extension to upload information identifying the applications or application components that were discovered on the end user system and any pertinent configuration information in step 343. The autoprofile system uses this information in step 332 to dynamically generate an HTML page 344 that is sent to the end user asking the end user to select the applications to be configured in step 333. In step 314, the end user selects the applications he or she wishes to have automatically configured and sends this information back to the autoprofile server in a response to an HTML form 345. The autoprofile server receives the selection information 345 in step 334 and evaluates the selected applications and the pertinent configuration information in order to determine the XML instructions to be sent and executed on the end user PC in step 335. The configuration XML instructions can be specifically configured to cause the configuration module to configure installed programs according to the SP's requirements and preferences. The configuration XML instructions instructs the client application extension to send information representative of the results of the configuration operations performed on the end user PC 347 to be stored in the end user configuration log. The autoprofile server receives the configuration log data 347 and stores the information in the end user configuration log in step 336. At a later time, the SP can review the end user configuration log as necessary to provide further technical support for the end user. The autoprofile server also reports the results 348 of the configuration operations to the end user in step 337 to indicate to the end user that each of the selected applications has been successfully or unsuccessfully configured to SP's requirements. Upon receiving the configuration report in step 318 the end user can verify that the applications selected were successfully or unsuccessfully configured to SP's requirements. Where a specific application was unsuccessfully configured, the end user can be referred to additional technical support resources. Optionally, the end user can be presented with a web page that allows the end user to request that the autoprofile server “undo” the configuration process for a given application.

Appendix A shows an example XML discovery document in accordance with the present invention and Appendix B provides the document type definition for example discovery document shown in Appendix A. Appendix C shows an example XML configuration document in accordance with the present invention and Appendix D provides the document type definition for example XML configuration document shown in Appendix C.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

[image]

[image]

[image]

[image]

[image]

[image]

[image]

[image]

[image]

[image]

[image]

[image]

[image]

[image]

[image]

[image]

[image]

What is claimed is:

1. A system for identifying an application located at a remote computer, said system comprising:
a profile server connected to said remote computer via a network, said profile server including an extension module, and said profile server being adapted for sending said extension module and data to and receiving data from said remote computer; and
a remote computer connected to said profile server via said network, said remote computer including a remote application adapted for receiving said extension module from said profile server and executing said extension module; said remote application further being adapted for sending data to and receiving data from said profile server;
wherein said remote computer includes at least one installed application component and said extension module is adapted for identifying that said application component is installed on said remote computer.

2. A system according to claim 1, wherein said extension module includes a plurality of executable functions and said extension module is adapted for identifying that said application component is installed on said remote computer by executing a plurality of said executable functions in a predefined sequence.

3. A system according to claim 2, wherein said predefined sequence is received from said profile server.

4. A system according to claim 2 wherein said predefined sequence is included with said extension module.

5. A system according to claim 2 wherein at least one of said executable functions is adapted for searching for a predefined file installed on said remote computer.

6. A system according to claim 1 wherein said remote application is a browser application adapted for displaying data received from said profile server.

7. A system according to claim 6 wherein said extension module is a plug-in module for said browser application.

8. A system according to claim 1 wherein said profile server sends data to said extension module representative of command instructions which instruct said extension module to search for application components installed on said remote computer.

9. A system according to claim 8 wherein said command instructions sent by said profile server to said extension module in XML format.

10. A system for configuring an application located at a remote computer, said system comprising:
a profile server connected to said remote computer via a network, said profile server including an extension module, and said profile server being adapted for sending said extension module and data to and receiving data from said remote computer; and
a remote computer connected to said profile server via said network, said remote computer including a remote application adapted for receiving said extension module from said profile server and executing said extension module; said remote application further being adapted for sending data to and receiving data from said profile server;
wherein said remote computer includes at least one installed application program and said extension module is adapted for configuring said application program according to a predefined application configuration.

11. A system according to claim 10, wherein said extension module includes a plurality of executable functions and said extension module is adapted for configuring said application installed on said remote computer by executing a plurality of said executable functions in a predefined sequence.

12. A system according to claim 11, wherein said predefined sequence is received from said profile server.

13. A system according to claim 11 wherein said predefined sequence is included with said extension module.

14. A system according to claim 11 wherein at least one of said executable functions is adapted for modifying a predefined file installed on said remote computer.

15. A system according to claim 10 wherein said remote application is a browser application adapted for displaying data received from said profile server.

16. A system according to claim 15 wherein said extension module is a plug-in module for said browser application.

17. A system according to claim 10 wherein said profile server includes command instructions and said profile server is adapted for sending data to said extension module representative of said command instructions which instruct said extension module to modify a predefined file installed on said remote computer.

18. A system according to claim 17 wherein said profile server is adapted for sending said command instructions to said extension module in XML format.

19. A system for identifying and configuring an application located at a remote computer, said system comprising:
a profile server connected to said remote computer via a network, said profile server including an extension module, and said profile server being adapted for sending said extension module and data to and receiving data from said remote computer; and
a remote computer connected to said profile server via said network, said remote computer including a remote application adapted for receiving said extension module from said profile server and executing said extension module; said remote application further being adapted for sending data to and receiving data from said profile server;
wherein said remote computer includes at least one installed application component and said extension module is adapted for identifying that said application component is installed on said remote computer and for configuring said application according to a predefined application configuration.

20. A system according to claim 19, wherein said extension module includes a plurality of executable functions and said extension module is adapted for identifying that said application component is installed on said remote computer and for configuring said application installed on said remote computer by executing a plurality of said executable functions in a predefined sequence.

21. A system according to claim 20, wherein said predefined sequence is received from said profile server.

22. A system according to claim 20 wherein said predefined sequence is included with said extension module.

23. A system according to claim 20 wherein at least one of said executable functions is adapted searching for a predefined file installed on said remote computer and at least one of said executable functions is adapted for modifying a predefined file installed on said remote computer.

24. A system according to claim 19 wherein said remote application is a browser application adapted for displaying data received from said profile server.

25. A system according to claim 24 wherein said extension module is a plug-in module for said browser application.

26. A system according to claim 19 wherein said profile server includes command instructions and said profile server is adapted for sending data to said extension module representative of said command instructions which instruct said extension module to search for and modify a predefined file installed on said remote computer.

27. A system according to claim 26 wherein said profile server is adapted for sending said command instructions to said extension module in XML format.

28. A system according to claim 19 where said extension module is adapted for prompting a user of said remote computer for authorization to configure said application.

29. A method of identifying an application located on a remote computer, said method comprising the steps of:
A) establishing a connection between a profile server and said remote computer;
B) transferring an extension module to said remote computer;
D) executing a discovery function of the extension module on said remote computer and generating data representative of the installed [applications and/or] application components and configurations on said remote computer;
E) transferring said data representative of the installed [applications, ]application components, and/or configurations to said profile server;

30. The method according to claim 29 further comprising the steps of:
F) querying a user of said remote computer to select which installed applications and/or application components said user desires to be configured;
G) for each installed application and/or application component, analyzing the data representative of the installed application and/or application component to determine the proper configuration for each;
H) transferring configuration data to the end user computer;
I) executing a configuration module of said extension module to configure each installed application and/or application component selected by the end user;
K) generating and transferring data representative of the results of configuration of each application and/or application component;
L) reporting the results of the configuration to the end user; and
M) storing the results of the process.

31. A method of identifying and configuring an application located on a remote computer, said method comprising the steps of:
A) establishing a connection between a profile server and said remote computer;
B) transferring an extension module to said remote computer;
D) executing a discovery function of the extension module on said remote computer and generating data representative of the installed [applications and/or] application components and configurations on said remote computer;
E) for each installed application and/or application component, analyzing the data representative of the installed application and/or application component to determine the proper configuration for each;
F) transferring configuration data to the end user computer;
G) executing a configuration function of said extension module to configure each installed application and/or application component selected by the end user.

32. The method according to claim 31 further comprising the steps of:
H) generating and transferring data representative of the results of configuration of each application and/or application component;
I) reporting the results of the configuration to the end user; and
J) storing the results of the process.

33. The method according to claim 31, after step D) executing the discovery function, further comprising the steps of:
D1) transferring said data representative of the installed [applications, ]application components, and/or configurations to said profile server; and
D2) querying a user of said remote computer to select which installed applications and/or application components said user desires to be configured;

34. An apparatus for identifying an application located on a remote computer comprising:
a profile server connected to said remote computer via a network, said profile server including at least one extension module adapted to be received by said remote computer and executed by an application located on said remote computer, a database of discovery instructions, adapted to be used by said extension module to identify at least one application located at said remote computer.

35. An apparatus according to claim 34, wherein said profile server further includes a database of configuration instruction adapted to be used by said extension module to configure at least one application located at said remote computer.
